(19) United States
(12) Patent Application Publication
(10) Pub. No.: US 2003/0152692 A1
(43) Pub. Date: Aug. 14, 2003

(54) Preparing method of radiation image conversion panel

(76) Inventors: Osamu Morikawa, Tokyo (JP); Yasushi Nakano, Tokyo (JP)

Correspondence Address: CANTOR COLBURN, LLP, 55 GRIFFIN ROAD SOUTH, BLOOMFIELD, CT, 06002

(21) Appl. No.: 10/360,392

(22) Filed: Feb. 6, 2003

(30) Foreign Application Priority Data
Feb. 13, 2002 (JP) JP2002-035204

(51) Int. Cl. B05B 5/00; B05D 1/36

(52) U.S. Cl. 427/157; 427/402

(57) ABSTRACT

A preparing method of a radiation image conversion panel comprising: forming a stimulable phosphor layer on a support while the stimulable phosphor layer being unformed on a peripheral portion around the stimulable phosphor layer on the support; and sealing the stimulable phosphor layer by superimposing a protective layer on the support formed thereon the stimulable phosphor layer while providing an adhesive agent on the peripheral portion, wherein the sealing step is conducted under a condition controlling humidity so that a moisture content of the stimulable phosphor layer is lower than the moisture content maintaining equilibrium with an atmosphere having a water partial pressure of 2.66×10³ Pa.

### FIELD OF THE INVENTION

The present invention relates to a method for preparing a radiation image conversion panel exhibiting superior production stability and higher sensitivity.

### RELATED ART

Up to this point, a method for imaging a radiation image on a radiation image conversion panel, employing a stimulable phosphor has generally been used.

This method employs a radiation image conversion panel having a stimulable phosphor layer on a support, as disclosed in U.S. Pat. No. 3,859,527 and JP-A 55-12144 (hereinafter, the term, JP-A means a Japanese Patent Application Publication No.). The stimulable phosphor layer of the radiation image conversion panel is exposed to the radiation-rays having been passed through a subject, which accumulate the radiation energy corresponding to radiation transmittance throughout the subject, onto the stimulable phosphor layer to form latent images (accumulated images). Then, the thus accumulated energy stored in respective portions is converted to emit light by scanning the stimulable phosphor layer with stimulating light (for which laser light is often employed), and the strength of the stimulated emission light is detected to obtain visible images. These images can be reproduced on various displays such as CRT, or on various media as a hard copy.

It is essential that the stimulable phosphor layer of the radiation image conversion panel employed in a radiation image conversion method exhibits a high radiation absorption rate and a high light conversion rate, and also fine image graininess and excellent image sharpness.

Usually, the stimulable phosphor layer needs to be thick enough to enable high radiation sensitivity. However, there is a limit since emission may not exit the phosphor layer due to scattering of emission among stimulable phosphor particles when the thickness is excessive.

Further, sharpness is enhanced by reducing the thickness of the stimulable phosphor layer, however too thin a layer decreases sensitivity.

As for graininess, since image graininess is determined by local fluctuation (quantum mottling) of the radiation quantum number or structural disorder (structure mottling) of the stimulable phosphor layer of the radiation image conversion panel, deteriorated image quality is caused by the increased mottling due to decrease of the radiation quantum numbers absorbed in the stimulable phosphor layer, or by increased mottling due to obvious structural fluctuation, when the thickness of the stimulable phosphor layer is decreased. Consequently, it is essential that the stimulable phosphor layer is thick enough to enhance image graininess.

Thus, the image quality and the sensitivity of the radiation image conversion method using a radiation image conversion panel are determined by the various factors afore-mentioned. Up to this point, many investigations have been made to improve the sensitivity and the image quality by adjusting plural factors.

Of these, as a means of improving radiation image sharpness, for example, many attempts have been made to improve the sensitivity and the sharpness by controlling the form of the stimulable phosphor.

A one example used as a method in the trials was a stimulable phosphor layer comprising minute pseudo-columnar blocks deposited onto the support having a patterned indented surface, as described in JP-A 61-142497.

Further, the following methods are disclosed, for example; to use a radiation image conversion panel comprised of a stimulable phosphor layer which has been subjected to a shock treatment to develop cracks among columnar blocks deposited the stimulable phosphor on the support having a minute patterned surface as described in JP-A 61-142500; to use a radiation image conversion panel comprised of a stimulable phosphor layer formed on the support, from which surface cracks are generated to be pseudo columnar as described in JP-A 62-39737; to provide a stimulable phosphor layer having voids is formed on the support by vapor deposition, followed by subjecting to a heat treatment to grow the voids to form cracks, as described in JP-A 62-110200.

The radiation image conversion panel comprised of a stimulable phosphor layer formed on the support is elongated columnar crystals inclined to the line normal to the support as disclosed in JP-A 2-58000.

All of the trials to control the shape of the stimulable phosphor layer are to make the columnar to prevent stimulated luminescence (stimulated emission) from diffusing in lateral direction (emitted light reaching the surface of the support by repeated reflection at the cracks (boundary of the columnar crystals)). Such prevention of lateral diffusion results in significantly enhanced sharpness of image formed by stimulated emission.

As for the radiation image conversion panel having the stimulable phosphor layer formed via gas phase growth (deposition), it is desired to have properties capable of use over a long period of time or multiple numbers of time without deterioration of the obtained radiation image quality. For that purpose, it is necessary that the foregoing stimulable phosphor layer of the radiation image conversion panel is effectively protected from physical or chemical stimulation. Specifically, deterioration by moisture needs to be seriously considered. Employed as a method to provide a protective layer to protect the stimulable phosphor layer covering the stimulable phosphor layer surface of the conversion panel support is to tightly seal the circumferential portion of the conversion panel.

This protective layer may be formed by directly coating a protective layer coating solution onto the stimulable phosphor layer, or by adhering a protective layer prepared separately in advance as described in JP-A 59-42500.

Further, the following methods to tightly seal the circumferential portion of the conversion panel may be employed, for example: to soak only the circumferential portion of the conversion panel in an organic polymer solution; to seal the formed polymer film by coating an organic polymer solution on the circumferential portion of the conversion panel; to seal the circumferential portion with a sealing material to fix the sealing material by a fixing member from outside (JP-A 61-237099); to seal the circumferential portion by covering it with an extended portion of the protective layer (JP-A 61-237100).

Furthermore, in order to maximally lower the interior humidity, a notched part is provided in the spacer to evaporate the interior moisture by heating or evacuation and to seal the notched part thereafter so that the stimulable phosphor layer is sealed in the area formed by a spacer adhering the fringe portions of the protective layer and the support as described in JP-A 2-85799. And still further, a method to enhance the durability of the conversion panel by injecting a moisture-free gas into the foregoing area during sealing is described in JP-A 1-316697. Other than these, sealing after drying is described in JP-A 6-308298 and JP-A 7-120598. Adhesion of the adhesive material or a spacer onto the support and the protective layer may potentially be uneven, due to differences of pressure and temperature between the interior and interior even after making the interior of the area sufficiently lowering humidity when the stimulable phosphor layer is sealed at a low enough humidity. To prevent this uneven adhesion, it is effective to provide a notched part in the adhesive material or spacer. However, in case of phosphor characteristics of which are easily affected by presence or infiltration of moisture, uneven drying may occur between the vicinity of the notch and the opposite end of the notched part when vacuum drying is employed. Thus, stable characteristics of the phosphor cannot be obtained and sensitivity of the phosphor may be decreased or the image quality may be affected after sealing. Consequently, improvement thereof has been desired.

When sealing the stimulable phosphor layer with the protective layer utilizing the spacer and the adhesive agent or by the adhesive agent with providing a notched part, an operation such as vacuum drying and the following gas exchange is a complex procedure. Especially when the stimulable phosphor easily absorbs moisture, the operation requires highly manipulative skills because the stimulable phosphor absorbs moisture from the ambient atmosphere unless each step of the operation is finished quickly.

### SUMMARY OF THE INVENTION

An aspect of the present invention is to provide a method for preparing a radiation image conversion panel minimizing deterioration by moisture, sealing the stimulable phosphor from the ambient atmosphere more easily and simply, and in particular, to provide a method for preparing a radiation image conversion panel exhibiting higher sensitivity and more stable characteristics, sealing a stimulable phosphor layer under low humidity conditions, which stimulable phosphor layer is obtained via gas phase growth.

The foregoing aspect of the present invention can be accomplished by the following structures.

Structure 1

A preparing method of a radiation image conversion panel comprising:

forming a stimulable phosphor layer on a support while the stimulable phosphor layer being unformed on a peripheral portion around the stimulable phosphor layer on the support; and

sealing the stimulable phosphor layer by superimposing a protective layer on the support formed thereon the stimulable phosphor layer while providing an adhesive agent on the peripheral portion,

wherein the sealing step is conducted under a condition controlling humidity so that a moisture content of the stimulable phosphor layer is lower than the moisture content maintaining equilibrium with an atmosphere having a water partial pressure of 2.66×10³ Pa.

Structure 2

A preparing method of a radiation image conversion panel comprising:

forming a stimulable phosphor layer on a support while the stimulable phosphor layer being unformed on a peripheral portion around the stimulable phosphor layer on the support;

fixing a spacer on the peripheral portion by utilizing an adhesive agent so as to surround the stimulable phosphor layer; and

sealing the stimulable phosphor layer by superimposing a protective layer on the spacer while providing an adhesive agent on the spacer,

wherein the sealing step is conducted under a condition controlling humidity so that a moisture content of the stimulable phosphor layer is lower than the moisture content maintaining equilibrium with an atmosphere having a water partial pressure of 2.66×10³ Pa.

Structure 3

A preparing method of a radiation image conversion panel comprising:

forming a stimulable phosphor layer on a support while the stimulable phosphor layer being unformed on a peripheral portion around the stimulable phosphor layer on the support;

fixing a protective layer on the support by providing an adhesive agent while a part of the peripheral portion being kept un-adhered so that an open area ratio of a space including the stimulable phosphor layer is not less than 10%; and

sealing the stimulable phosphor layer with the protective layer and the support by providing an adhesive agent to the un-adhered part of the peripheral portion and

wherein the sealing step is conducted under a condition controlling humidity so that a moisture content of the stimulable phosphor layer is lower than the moisture content maintaining equilibrium with an atmosphere having a water partial pressure of 2.66×10³ Pa.

Structure 4

A preparing method of a radiation image conversion panel comprising:

forming a stimulable phosphor layer on a support while the stimulable phosphor layer being unformed on a peripheral portion around the stimulable phosphor layer on the support;

fixing a spacer on the peripheral portion and fixing a protective layer on the spacer with utilizing an adhesive agent, the spacer having a notched part so that an open area ratio of a space including the stimulable phosphor layer is not less than 10%; and

sealing the stimulable phosphor layer by closing the notched part of the spacer,

wherein the sealing step is conducted under a condition controlling humidity so that a moisture content of the stimulable phosphor layer is lower than the moisture content maintaining equilibrium with an atmosphere having a water partial pressure of 2.66×10³ Pa.

Structure 5

The preparing method described in any one of above STRUCTUREs 1 to 4, wherein the sealing step is conducted under a condition controlling humidity so that a moisture content of the stimulable phosphor layer is lower than the moisture content maintaining equilibrium with an atmosphere having a water partial pressure of 1.33×10³ Pa.

Structure 6

The preparing method described in above STRUCTURE 5, wherein the sealing step is conducted under a condition controlling humidity so that a moisture content of the stimulable phosphor layer is lower than the moisture content maintaining equilibrium with an atmosphere having a water partial pressure of 0.66×10³ Pa.

Structure 7

The preparing method of described in any one of above STRUCTUREs 1 to 6, wherein the stimulable phosphor layer contains stimulable phosphor represented by following Formula (1), and the stimulable phosphor layer is formed to be a thickness of not less than 50 μm by a vapor growth method,

M¹X.aM²X′₂.bM³X″₃:cA Formula (1)

wherein M¹ represents an alkali metal selected from the group consisting of Li, Na, K, Rb and Cs; M² represents a divalent metal selected from the group consisting of Be, Mg, Ca, Sr, Ba, Zn, Cd, Cu and Ni; M³ represents a trivalent metal selected from the group consisting of Sc, Y, La, Ce, Pr, Nd, Pm, Sm, Eu, Gd, Tb, Dy, Ho, Er, Tm, Yb, Lu, Al, Ga and In; X, X′ and X″ each represent a halogen selected from the group consisting of F, Cl, Br and I; A represents a metal selected from the group consisting of Eu, Tb, In, Ga, Cs, Ce, Tm, Dy, Pr, Ho, Nd, Yb, Er, Gd, Lu, Sm, Y, Tl, Na, Ag, Cu and Mg; and a, b and c each represent 0≦a<0.5, 0≦b<0.5, 0<c≦0.2.

Structure 8

The preparing method described in STRUCTURE 7, wherein in Formula (1), M¹ represents an alkali metal selected from the group consisting of K, Rb and Cs.

Structure 9

The preparing method described in STRUCTUREs 7 or 8, wherein in Formula (1), X represents a halogen atom selected from Br and I.

Structure 10

The preparing method described in STRUCTUREs 7, 8 or 9, wherein in Formula (1), M² represents a divalent metal selected from the group consisting of Be, Mg, Ca, Sr and Ba.

Structure 11

The preparing method described in any one of STRUCTUREs 7 to 10, wherein in Formula (1), M³ represents a trivalent metal selected from the group consisting of Y, Ce, Sm, Eu, Al, La, Gd, Lu, Ga and In.

Structure 12

The preparing method described in any one of STRUCTUREs 7 to 11, wherein in Formula (1), b represents 0≦b≦0.01.

Structure 13

The preparing method described in any one of STRUCTUREs 7 to 12, wherein in Formula (1), A represents a metal selected from the group consisting of Eu, Cs, Sm, Tl and Na.

Structure 14

The preparing method described in any one of STRUCTUREs 1 to 4, wherein the stimulable phosphor layer comprises stimulable phosphor having columnar crystals.

Structure 15

The preparing method described in STRUCTURE 15, wherein the columnar crystals contain stimulable phosphor represented by following Formula (2) as a primary component,

CsX:A Formula (2)

wherein in Formula (2), X represents Br or I, A represents Eu, In, Ga or Ce.

Structure 16

The preparing method described in any one of STRUCTUREs 1 to 4, wherein the stimulable phosphor layer is formed on the support by a vapor growth method.

### BRIEF DESCRIPTION OF THE DRAWINGS

FIG. 1(a) a cross-sectional view of from one side of a radiation image conversion panel sealing stimulable phosphor, employing a support, a protective layer and a spacer or adhesive agent.

FIG. 1(b) a cross-sectional view from the upper side of the radiation image conversion panel cut by the plane A-A′ of FIG. 1(a).

FIG. 2. a cross-sectional photograph of a stimulable phosphor layer comprised of columnar crystals.

FIG. 3. example representation of a stimulable phosphor layer being formed onto a support with deposition.

FIG. 4. an example of a cross-sectional view of a stimulable phosphor structure of the present invention.

FIG. 5. a schematic view of a radiation image conversion method using a radiation image conversion panel of the present invention.

FIG. 6. an example of a schematic view of a preparation method of a stimulable phosphor layer onto a support via deposition.

FIG. 7. an example showing luminance measuring points on a radiation image panel to X-ray.

### DETAILED DESCRIPTION OF THE INVENTION

Regarding a radiation image conversion panel comprising a support, a stimulable phosphor layer formed on a support and a protective layer in which the radiation image conversion panel is tightly sealed by providing a adhesive agent, or a spacer and adhesive agent surrounding the circumferential portion of the stimulable phosphor placed between the support and the protective layer, uniform adhesion can be achieved by a method of providing a notched part in a part of the spacer, or in the adhesive agent, when the support and the protective layer are sealed by employing a adhesive agent, or by putting a spacer between the support and the protective layer and adhering them to each other with a adhesive agent. When the circumferential portion of the conversion panel is sealed simultaneously, the sealing portion can usually not be completely sealed or an unevenly adhered portion may be breached by expansion of air due to differences of ambient temperature after sealing. Before sealing the notched part, the space is dried with evacuation for instance, and then, the vent hole is sealed after injecting a dry gas. Further, tight sealing of the notch is accomplished in a dry gas atmosphere to prevent any moisture from being introduced into the space.

However, in such a method, gas or moisture from ambient atmosphere may be introduced into the space through the notched part even after drying if the humidity or the temperature of the ambient atmosphere at the time of sealing is high or stimulable phosphor especially sensitive to moisture is used. Trapped gas or moisture causes the stimulable phosphor to absorb moisture, resulting in deterioration of initial characteristics. Also, the degree of moisture absorption is greatly affected by the ambient atmosphere during production, resulting in a considerable variation among conversion panels.

In this invention, there are a support, a stimulable phosphor layer formed on the support and a protective layer, and further there is provided a adhesive agent, or a spacer and adhesive agent, surrounding the circumferential portion of the stimulable phosphor layer between the support and the protective layer. It is intended to solve foregoing problems by increasing the open area ratio of the notched part when the stimulable phosphor is sealed into the sealed space under a predetermined condition.

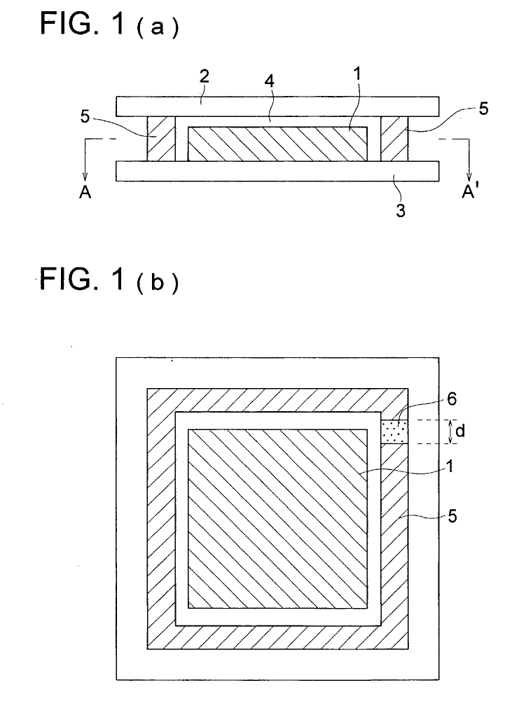

FIGS. 1(a) and 1(b) each shows example of a radiation image conversion panel comprising a support, a protective layer and a spacer or a adhesive agent which surround a stimulable phosphor layer, after the stimulable phosphor layer has been formed on the support. FIG. 1(a) is a cross-sectional view of the radiation image conversion panel looking from side. Stimulable phosphor 1 is provided on support 3, and the phosphor is tightly sealed adhering the support with protective layer 2 provided on stimulable phosphor 1 via spacer 5. Further, 4 represents a low refractive index layer (a gas). FIG. 1(b) is a cross-sectional view taken on line A-A′ of FIG. 1(a). Notched part 6 having a length of d is provided in FIG. 1(b).

In this invention, “an open area ratio of the surface area of the sealed area is not less than 10%” indicates the area ratio of an open area to the surface area of the inner space formed by the support, the protective layer and the spacer. Consequently, the open area is in a part of the spacer, and is in a part of the side of the panel in the figure, and obviously the open area ratio is a minute value comparing to the surface area of the inner space of the panel. For example, in case when the size of the radiation image conversion panel is 410 mm×410 mm, the area of both plain surfaces of the panel is about 336,200 mm². The total thickness is about 600 μm, supposing the thickness of the phosphor to be 300 μm and the thickness of the low refractive layer explained later (gas) being about 300 μm. The total surface area of the 4 side surfaces is 984 mm², so that the sum of the surface areas is about 337,184 mm². If d in FIG. 1 is 10 mm, namely in case when the spacer, the support and the protective layer are sealed leaving the 10 mm unsealed, the open area formed here is 6 mm², and 6/337,184×100(%), that is, 0.0018% is the ratio of the open area (open area ratio).

Accordingly, in this invention, the open area is sealed under the condition of the open area ratio of not less than 10% after the sealed area is dried by evacuation or heating. The larger open area ratio is preferred to eliminate the local unevenness in drying of phosphor. For example, the following case is contained. Firstly, a stimulable phosphor layer is formed on a support. Subsequently, under that status (in this case, the open area ratio is almost 50%), the stimulable phosphor layer on the support is dried and the protective layer is overlaid and the stimulable phosphor layer is sealed by using the protective layer and the spacer under the condition controlling the humidity so that the moisture content of the stimulable phosphor layer is less than the moisture content maintaining equilibrium with the ambient atmosphere having a water partial pressure of 2.66×10³ Pa. Even when the stimulable phosphor layer is picked out and allowed to stand in the normal atmosphere after the formation, resulting in increased moisture content of the phosphor, it is acceptable to seal the stimulable phosphor layer under the humidity-controlled condition after drying the stimulable phosphor layer until the moisture content of the phosphor becomes less than that of foregoing moisture content. Alternatively, the phosphor layer may be sealed in the space formed by the protective layer and spacer or the adhesive agent without any drying process, if the phosphor layer can be maintained under the condition of low humidity. In these cases, it is preferred that there is no need to seal the notched part provided temporarily.

Further, in this invention, there is not always necessary to use the spacer, for example, in case when a flexible plastic film is employed as the protective layer or the support, the support and the protective layer can be directly sealed using the adhesive agent.

In the present invention, the deterioration of the stimulable phosphor layer after locally uneven drying is prevented by making the open area ratio being larger, and at the time of sealing, it is necessary to seal under the condition of low humidity not to absorb moisture again after moisture content is lowered to dry enough by drying. The humidity may not be decided from one viewpoint. For example, the phosphor layer may be sealed in a short time even when being at high humidity, and the moisture absorption of the phosphor layer is little even when allowed to stand at low humidity. Therefore, in this invention the humidity is preferably to be determined by the moisture content of the stimulable phosphor layer. Because the value differs to a certain degree depending on the kind of the stimulable phosphor, it is better to define by the moisture content of the phosphor being equilibrium with atmosphere around the phosphor. In the invention, the stimulable phosphor layer is sealed under the condition that the moisture content of the phosphor layer is less than that maintaining equilibrium with the ambient atmosphere having a water partial pressure of 2.66×10³ Pa. Further, in case when the stimulable phosphor layer is easy to absorb moisture, the phosphor layer needs to be sealed under the condition that the moisture content of the phosphor layer is less than that maintaining equilibrium with the ambient atmosphere having a water partial pressure of 1.33×10³ Pa in absolute humidity.

Examples of the stimulable phosphor used in the radiation image conversion panel of the present invention include: phosphor represented by the formula of BaSO₄:Ax, as described in JP-A 48-80487; phosphor represented by the formula of MgSO₄:Ax, as described in JP-A 48-80488; phosphor represented by the formula of SrSO₄:Ax, as described in JP-A 48-80489; phosphor added at least one of Mn, Dy or Tb to Na₂SO₄, CaSO₄ or BaSO₄, as described in JP-A 51-29889; phosphor of BeO, LiF, MgSO₄ or CaF₂, as described in JP-A 52-30487; phosphor of Li₂B₄O₇:Cu, Ag, as described in JP-A 53-39277; phosphor of Li₂O.(Be₂O₂)ₓ:Cu, Ag, as described in JP-A 54-47883; phosphor represented by the formula of SrS:Ce, Sm, SrS:Eu, Sm, La₂O₂S:Eu, Sm, or (Zn, Cd)S:Mnₓ as described in U.S. Pat. No. 3,859,527. Also, the examples include: phosphor of ZnS:Cu, Pb, barium aluminate phosphor represented by the formula of BaO.ₓAL₂O₃:Eu, alkaline earth metal silicate type phosphor represented by the formula of M(II)O.ₓSiO₂:A, as described in JP-A 55-12142.

Further, the examples include: alkaline earth fluorohalide phosphor represented by the formula of (Ba_{1-x-y}MgₓCay), as described in JP-A 55-12143; phosphor represented by the formula of LnOX:ₓA, as described in JP-A 55-12144; phosphor represented by the formula of (Ba₁₋ₓM(II)ₓ)fₓ:_{y}A, as described in JP-A 55-12145; phosphor represented by the formula of BaFX:ₓCe, _{y}A, as described in JP-A 55-84389; rare earth element activated divalent metal fluorohalide phosphor represented by the formula of M(II)FX.ₓA:_{y}Ln, and phosphor represented by the formula of ZnS:A, CdS:A, (Zn, Cd)S:A, X as described in JP-A 55-160078; phosphor represented by any of the following formulas of xM₃(PO₄)₂.NX₂:_{y}A or xM₃(PO₄)₂:yA, as described in JP-A 59-38278; phosphor represented by the any of the following formulas of nReX₃.mAX′₂:xEu or nReX₃.mAX′₂:xEu, ySm, as described in JP-A 59-155487; and bismuth activated alkali halide phosphor represented by the formula of M(I)X:xBi, as described in JP-A 61-228400.

Of these, specifically alkali halide type stimulable phosphor represented by following formula (1) is preferable as described in JP-A Nos. 61-72087, 2-58000.

M¹X.aM²X′₂.bM³X″₃:cA Formula (1)

wherein M¹ is an alkali metal selected from Li, Na, K, Rb and Cs; M2 a divalent metal selected from Be, Mg, Ca, Sr, Ba, Zn, Cd, Cu and Ni; M3 is a trivalent metal selected from Sc, Y, La, Ce, Pr, Nd, Pm, Sm, Eu, Gd, Tb, Dy, Ho, Er, Tm, Yb, Lu, Al, Ga and In; X, X′ and X″ each are a halogen selected from F, Cl, Br and I; A is a metal selected from Eu, Tb, In, Ga, Cs, Ce, Tm, Dy, Pr, Ho, Nd, Yb, Er, Gd, Lu, Sm, Y, Tl, Na, Ag, Cu and Mg; and a, b and c each are ranges of numbers of 0≦a<0.5, 0≦b<0.5, 0<c≦0.2.

These alkali halide type stimulable phosphors are layered on a support by vapor growth method, forming thin long columnar crystals being inclined to the line normal to the support surface. (Of course, the crystals may be vertical to the support surface, without being inclined). Since the formation of the columnar crystals prevents stimulated luminescent (or stimulated emission) from diffusion in lateral direction, a feature using these phosphor is to obtain excellent sharpness of images by stimulated emission. Of these alkali halide type stimulable phosphor, RbBr type and CsBr type phosphor are preferable due to high luminance and high image quality, however these are easily affected by moisture. Consequently, the combined effect of the above phosphor and the preparation method of the present invention is significantly high.

In this invention, specifically preferable phosphor is represented by following Formula (2):

CsX:A Formula (2)

wherein X represents Br or I; A represents Eu, In, Ga or Ce.

Of these, CsBr type phosphor exhibits high luminance and high image quality, and is preferable due to a high effect of a combination with the sealing method (the preparation method) of this invention.

The columnar crystals formed by employing these stimulable phosphor preferably used in the invention, that is, crystals are growing in columnar at certain intervals, are obtained by the method as described in foregoing JP-A 2-58000.

Namely, the stimulable phosphor layer comprised of independent elongated columnar crystals is prepared by the method of gas phase growth (deposition) supplying vapor or raw material of the stimulable phosphor onto the support.

For example, almost vertical columnar crystals to the support base surface are obtained by incident of the vapor stream of the stimulable phosphor to the support base with an angle of the range of 0 to 5 degree to the vertical direction.

In these cases, the distance of the closest part between the support and the crucible is preferably to setup to about 10 to 60 cm in accordance with an average range of the stimulable phosphor.

A stimulable phosphor as an evaporation source may be melted homogeneously or molded by a press or hot plate press, followed by being charged into a crucible. Further, it is preferred to conduct a degassing treatment. Evaporation of a stimulable phosphor from the evaporation source can be conducted by scanning with an electron beam ejected by an electron gun but other methods may be applied to perform the evaporation.

The evaporation source is not necessarily a stimulable phosphor and raw material of a stimulable phosphor may be mixed thereto.

With respect to activators, a mixture of an activator with a basic substance may be evaporated. Alternatively, the basic substance is evaporated, followed by doping the activator. For example, CsBr, as basic substance is evaporated alone, followed by doping In as an activator. In this case, since respective crystals exist isolatedly, doping becomes feasible even in case of a thick phosphor layer and difficulty is proceeding crystal growth results in no reduced MTF.

Doping is performed by allowing a doping agent (dopant) to be introduced into the basic substance layer of a phosphor by means of thermal diffusion or iron injection.

In order to enhance the modulation transfer function (MTF) of the stimulable phosphor layer comprised of the columnar crystals, the columnar crystal size is preferably 0.5 to 50 μm, and more preferably 0.5 to 20 μm. The columnar crystal size refers to an average value of diameters of circles equivalent to the section (or circular equivalent diameter of the section) when viewed from the side parallel to the support surface. Columnar crystals thinner than 1 μm result in lowed MTF due to scattering of stimulated luminescence by the columnar crystals; on the contrary, columnar crystals thicker than 50 μm result in lowered directionality of stimulated luminescence, and also lowering the MTF.

Examples of vapor growth (deposit) of the stimulable phosphor include an evaporation method, a sputtering method and a CVD method.

A vacuum evaporation method is conducted in such a manner that after placing a support in an evaporation apparatus, the inside of the apparatus is evacuated to a vacuum degree of 1.333×10⁻⁴ Pa and subsequently, at least a stimulable phosphor is evaporated with heating by the resistance heating method or electron-beam method to cause the phosphor to deposit at a slant on the surface of the support to a desired thickness. As a result, a stimulable phosphor layer containing no binder is formed, provided that the foregoing evaporation stage may be divided into plural times to form the stimulable phosphor layer. In this evaporation stage, plural resistance heaters or electron beams may be used to perform vacuum evaporation. Alternatively, raw material of a stimulable phosphor is evaporated using plural resistance heaters or electron beams and an intended stimulable phosphor is synthesized on the support, simultaneously forming a stimulable phosphor layer. Vacuum evaporation may be conducted while cooling or heating the substance to be deposited thereon. After completion of vacuum evaporation, the stimulable phosphor layer may be subjected to a heating treatment.

A sputter deposition method is conducted in such a manner that after setting a support in a sputtering apparatus, the inside of the apparatus is evacuated to a vacuum degree of 1.33×10⁻⁴ Pa and then inert gas used for sputtering such as Ar and Ne is introduced thereto at a gas pressure of ca. 1.333×10⁻¹ Pa, subsequently, sputtering is carried out in the inclined direction with targeting the stimulable phosphor to cause the phosphor to deposit at a slant on the surface of the support so as to have a desired thickness. Similarly to the vacuum evaporation, the sputtering stage may be divided to plural steps to form a stimulable phosphor layer. Using plural raw materials of a stimulable phosphor as a target, sputtering is simultaneously or successively carried out to form an intended stimulable phosphor layer on the support. Gas such as O₂ and H₂ may optionally be introduced to perform reactive sputtering. Sputtering may be carried out while heating or cooling substrate to be deposited thereon. After completion of sputtering, the stimulable phosphor layer may be subjected to a heating treatment.

A CVD method is a method in which an intended stimulable phosphor or an organic metal compound containing a raw material of the stimulable phosphor is degraded using energy such as heat or high-frequency electric power to form a stimulable phosphor layer containing no binder on the support, which enables growing respectively long thin columnar crystals in the inclined direction to the line normal to the surface of the support.

The thickness of the thus formed stimulable phosphor layer, depending on aimed radiation sensitivity to radiation of an intended radiation image conversion panel and the kind of stimulable phosphor, is preferably selected from the range of 50 to 1,000 μm, and more preferably 80 to 800 μm.

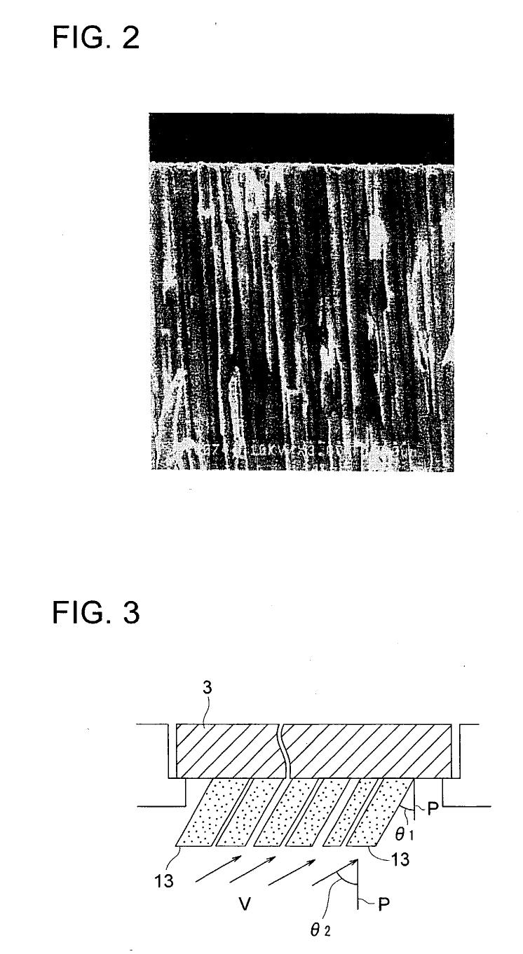

FIG. 2 is an electron micrograph showing the cross section of the stimulable phosphor layer comprised of the columnar crystals formed on the support with the foregoing methods (which was photographed using scanning type electron microscope S-800, manufactured by Hitachi Co., Ltd., at 3,000 times.).

These columnar crystals may be obtained with the method as described in the foregoing JP-A 2-58000, in which vapor of the stimulable phosphor or raw material of the phosphor is supplied and deposited onto the support by gas phase growth (deposition), such as vacuum evaporation.

FIG. 3 shows formation of the stimulable phosphor layer on the support by deposition. In FIG. 3, 13 illustrates typically columnar crystals of a stimulable phosphor formed on the support. Supposing an incident angle of the vapor stream (V) of the stimulable phosphor to the normal line direction (P) of the support to be θ2, the angle of the formed columnar crystals to the direction (P) normal to the support is indicated by θ1. Since the columnar crystals are formed at a given angle of θ1, depending on the incident angle θ2, the columnar crystals almost vertical (θ1 is approximately 0 degree) to the base surface are obtained in the invention, when the vapor stream of the stimulable phosphor is injected at an angle of 0 to 5 degree (i.e., θ2 is 0 to 5 degrees) to the direction vertical to the base as described above.

The stimulable phosphor layer formed on the support contains no binding agent, leading to superior directionality and enhanced directionality of stimulating light and stimulated luminescence and enabling formation of a thicker phosphor layer, as compared to radiation image conversion panel having a dispersion-type stimulable phosphor layer, in which a stimulable phosphor is dispersed in a binder. Moreover, reduced scattering of stimulating light in the stimulable phosphor layer-results in enhanced sharpness.

Further, spacing between columnar crystals may be filled with a filler such as a binding agent to strengthen the phosphor layer. Furthermore, material exhibiting relatively high light absorbance or reflectance may be used as filler. The use thereof prevents lateral diffusion of stimulating light entering into the phosphor layer, in addition to the foregoing strengthening effect.

The material exhibiting high reflectance refers to one exhibiting a high reflectance with respect to stimulating light (500 to 900 nm, specifically 600 to 800 nm), including metals such as aluminum, magnesium, silver and indium, white pigments and color materials ranging green to red.

White pigments can also reflect stimulating light. Examples thereof include TiO₂ (anatase type, rutile type), MgO, PbCO₃.Pb(OH)₂, BaSO₄, Al₂O₃, M(II)FX [in which M(II) is at least one of Ba, Sr or Ca, X is at least one of Cl or Br], CaCO₃, ZnO, Sb₂O₃, SiO₂, ZrO₂, lithopone (BaSO₄.ZnS), magnesium silicate, basic lead silicosulfate, basic lead phosphate, and aluminum silicate. These pigments exhibit high covering power and have a refractive index high, whereby stimulated luminescence is easily scattered through reflection or refraction, leading to enhanced sensitivity of the radiation image conversion panel.

Examples of material exhibiting high light absorbance include carbon, chromium oxide, nickel oxide, iron oxide, and color materials of blue. Of these, carbon absorbs stimulated luminescence.

Color materials may be any organic or inorganic color materials. Examples of organic color materials include Zapon fastblue 3G (product of Hoechst Marion Roussel, Ltd.), Estrol Brillblue N-3RL (product of Sumitomo Chemical Co., Ltd.), D&C Blue No.1 (producy of National Aniline Co.), Spirit Blue (Hodogaya Chemical Co., Ltd.), Oilblue No. 603 (product of Orient Co.), Kiton Blue A (product of Ciba-Geigy AG. GmbH.), Aisen Catironblue GLH (Hodogaya Chemical Co., Ltd.), Lakeblue AFH (product of Kyowa Industry Co., Ltd.), Primocyanine 6GX (Inabata & Co., Ltd.), Brillacid Green 6BH (product of Hodogaya Chemical Co., Ltd.), Cyanblue BNRCS (product of TOYO INK MFG. CO., LTD.), and Lyonol Blue SL (product of TOYO INK MFG. CO., LTD.). There are also cited organic complex colorants such as Color Index Nos. 24411, 23160, 74180, 74200, 22800, 23154, 23155, 24401, 14830, 15050, 15760, 15707, 17941, 74220, 13425, 13361, 13420, 11836, 74140, 74380, 74350, and 74460. Examples of inorganic colorants include ultramarine, cobalt blue, cerulean blue, chromium oxide, and TiO₂—ZnO—Co—NiO type pigments.

As to the support used for the radiation image conversion panel of the invention, a low moisture permeability support is preferable, and various types of glass, polymer material and metal may be employed. Preferable supports are, for example, plate glass such as quartz, borocilicate glass and chemically tempered glass; plastic film such as cellulose acetate film, polyester film, polyethylene terephthalate film, polyamide film, triacetate film, and polycarbonate film; metal sheet such as aluminum sheet and copper sheet or metal sheet having a coated layer of the oxide of the foregoing metals. The surface of the support may be smooth, or matte to enhance adhesion property with the stimulable phosphor layer.

In this invention, the adhesion layer may optionally be provided on the surface of the support in advance to enhance adhesion property between the support and the stimulable phosphor layer.

The thickness of the support is variable depending on the kind of the support and is usually 80 to 2,000 μm, and preferably 80 to 1,000 μm in terms of handling.

As to a protective layer of this invention may be employed material exhibiting high translucency and capable of being easily formed to sheet. Examples are plate glass such as quartz, borocilicate glass and chemically tempered glass; and organic polymer such as PET, OPP and polyvinyl chloride.

The protective layer of this invention may be a single layer or multi-layers, more than 2 layers of different materials. A composite film comprised of more than 2 layers of polymer films may be employed. The production methods of the composite polymer films are such as a dry laminate method, an extrusion laminate method and a multi-extrusion laminate method. The combination of more than 2 protective layers is not only limited to the combination of organic polymers, but also are the combination of plate glasses and that of a plate glass and an organic polymer. Methods to combine a plate glass and an organic polymer include forming a protective layer by directly coating a coating solution on a plate glass, or allowing a polymer protective layer separately prepared in advance to adhere onto a plate glass. Further, the protective layers of more than 2 layers may be cohered each other or separated.

The thickness of the protective layer of this invention is 10 μm to 3 mm in practice. The thickness of the protective layer is preferably not less than 100 μm to obtain sufficient moisture resistance and shock-proofing, and is more preferably not less than 500 μm, obtaining the significantly durable conversion panel by providing the protective layer.

Further, when a plate glass is used for the protective layer, it is extremely superior in moisture resistance and specifically preferred.

The protective layer is desired to exhibit high transmittance in the broad wavelength region, to transmit effectively stimulating light and stimulated emission. The transmittance is not less than 60%, and preferably not less than 80%. Materials meeting the foregoing include quartz glass and borosilicate glass. Borosilicate glass exhibits transmittance of more than 80% in the wavelength region of 330 nm to 2.6 μm, and quartz glass exhibits high transmittance in the shorter wavelength region.

Additionally, providing an antireflection layer comprised of MgF2 for instance on the surface of the protective layer is preferred, resulting in effective transmission of stimulating light and stimulated emission, together with the effect decreasing deterioration of sharpness. Refractive index of the protective layer is not specifically defined, and that of many materials used in practice is between 1.4 and 2.0.

Further, to enhance sharpness, glass may be provided with a function to absorb stimulating light by coloring with a coloring agent such as lead phosphate.

Thus, there may be methods of laminating glass with tinted film containing a color material (pigment or dye) absorbing stimulating light; providing a layer containing dye or pigment by coating on an ether side of glass; allowing a dispersed pigment or coloring agent as a color material to be contained in glass itself.

A preparing method of a colored film may be to form a layer containing a color material (pigment or dye) by coating on the surface of a plastic film kneading a color material or a plastic film together. The colored glass may be obtained by pasting a colored plastic film onto a glass surface using a adhesive.

Further, a pigment or dye dispersed or dissolved in a binder (organic polymer such as liquid glass and polyvinyl butyrale) being adhesive to glass may directly be coated on glass.

As a spacer, materials are not specifically limited so far as being capable to maintain the stimulable phosphor layer in a insulated state from an exterior atmosphere, and glass, ceramics, metal and plastics can be employed.

A spacer preferably exhibits moisture permeability of less than 30 g/m²·24 hr. Excessive moisture permeability deteriorates the stimulable phosphor layer by moisture penetrated from exterior:

The thickness of the spacer is preferably greater than that of the stimulable phosphor layer. Since the width of the spacer is determined mainly according to moisture resistance (moisture permeability) of the tight-sealed portion of this spacer and the support, and this spacer and the protective layer, the width is preferably 1 to 30 mm. The spacer of too narrow width is not preferred in terms of stability, strength and moisture resistance of the spacer. While, excessively broad width is also not preferred because the radiation image conversion panel increases in size more than necessity.

Moisture permeability of the tight-sealed portion of the spacer and the support, and the spacer and the protective layer, is preferably not more than 30 g/m²·24 hr.

The spacer is required to be tightly sealed to the support and the protective layer in terms of providing moisture resistance to the conversion panel and maintaining the low refractive index layer at a given thickness. The adhesive agent is employed to cause the spaces to adhere to the support and the protective layer.

In the present invention, the adhesive agent is used to seal the spacer tightly to the support, and to the protective layer, and an adhesive agent exhibiting moisture resistance is used for the purpose. Exemplary examples of adhesive agents include, for example, organic polymer type adhesive agents such as epoxy type resin, phenol type resin, cyanoacrylate type resin, vinyl acetate type resin, vinyl chloride type resin, urethane type resin, acrylic type resin, ethylene vinyl acetate type resin, olefin type resin, chloroprene type rubber, and nitrile type rubber; silicon type adhesive agents; inorganic type adhesive agents containing alumina or silica as a main component. Of these, epoxy type resin and silicon type resin used to seal semiconductors or electronic parts are preferable in terms of superior moisture resistance. Specifically, epoxy type adhesive agent is preferable in terms of low moisture permeability.

It is also possible to allow the support to adhere to the protective layer with only the adhesive agent without providing a spacer.

In this invention, a low refractive layer may be provided. The low refractive layer is comprised of material exhibiting lower refractive index than the protective layer. The presence of this layer can decrease deterioration of sharpness even when the protective layer is thick. For example, the following material can be used, which is preferably used in the state of a thin layer formed by gas phase growth such as vacuum evaporation deposition method.

| Material | Refractive index |
|---|---|
| CaF | 1.23 to 1.26 |
| Na₂AlF₆ | 1.35 |
| MgF₂ | 1.38 |
| SiO₂ | 1.46 |

The following aqueous layer can also be used.

| Material | Refractive index |
|---|---|
| Ethyl alcohol | 1.36 |
| Methyl alcohol | 1.33 |
| Diethyl alcohol | 1.35 |

As the low refractive layer of the invention, a gas layer of air, nitrogen or argon, or a vacuum layer of which refractive indexes are substantially 1, is specifically preferred, preventing sharpness from being lowered.

The thickness of the low refractive layer of the invention is practically 0.05 μm to 3 mm. The low refractive layer of the invention may be in the state of tightly sealed with the stimulable layer, or may be separate from the stimulable layer. One method to tightly seal the low refractive layer and the stimulable layer is to use an adhesive agent, and in this case, a refractive index of the adhesive agent is preferred to be close to that of the stimulable layer or to that of the low refractive index layer.

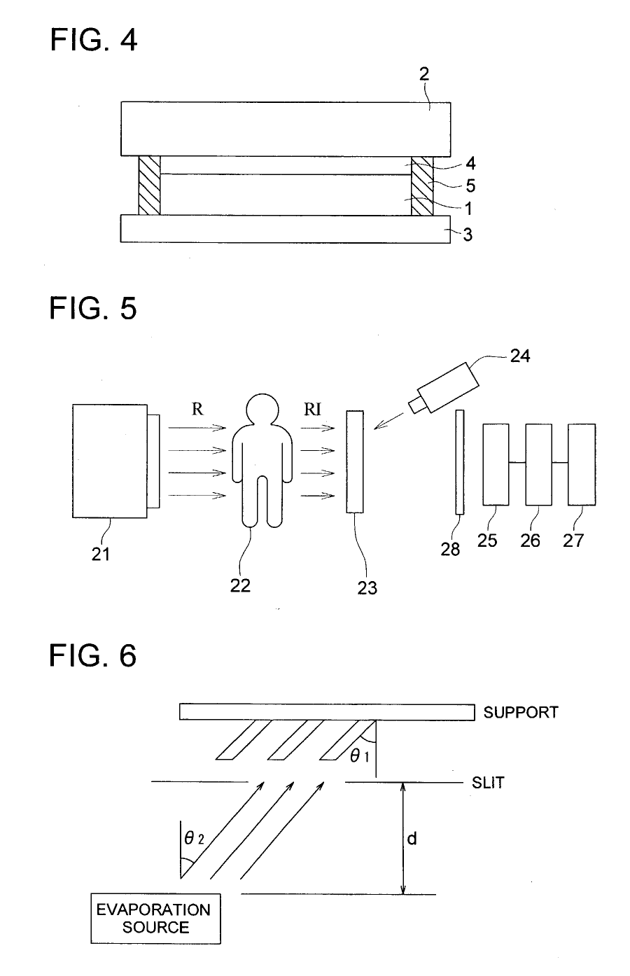

FIG. 4 is a cross-sectional view showing an example of a structure of the radiation image conversion panel, provided with an air layer as a low refraction layer. The thickness of air layer 4 is uniformly maintained by providing spacer 5 on the fringe portion of the panel to surround stimulable phosphor layer 1. In this case, a notched part is not formed in the spacer.

FIG. 5 schematically illustrates the radiation image conversion method using the radiation image conversion panel of the invention.

In FIG. 5, 21 is a radiation generating apparatus, 22 is a subject, 23 is a radiation image conversion panel relating to the invention, 24 is a stimulating light source (such as a laser light source), 25 is the photoelectric conversion device detecting the stimulated luminescence emitted from the conversion panel, 26 is a device reproducing a signal detected by 25 as an image, 27 is a device displaying the reproduced image, 28 is a filter separating the stimulated luminescence from the stimulating light to transmit only stimulated luminescence. 25 and subsequent devices are not limited to the above ones, and any system capable to reproduce images from optical information by 23 can be used.

As indicated in FIG. 5, the radiation (R) from radiation generating apparatus 21 passes through subject 22, and enters into radiation image conversion panel 23 (IR). The incident radiation is absorbed in panel 23, and its energy is stored to form an accumulated image of the radiation transmission image.

Subsequently, the accumulated image is excited by the stimulating light from stimulating light source 24 to emit the stimulated luminescence.

The intensity of the emitted stimulated luminescence is in proportion to the amount of the stored radiation energy, and this optical signal is photoelectrically converted with photoelectric conversion device 25 such as a photomultiplier, the thus converted signal is reproduced as an image by imaging apparatus 26; the image is displayed on image display apparatus 27, in which the radiation transmitted image can be observed.

### EXAMPLES

The present invention will be further explained based on examples, but it is not limited to these examples.

### Example 1

Preparation of Radiation Image Conversion Panel Samples 1 to 7

The stimulable phosphor layer containing stimulable phosphor (CsBr:Eu) was formed using a vacuum evaporation apparatus shown in FIG. 6 on the surface of the support of 1 mm thick, 410 mm×410 mm size crystallized glass (product of Nippon Electric Glass Co., Ltd.).

In a vacuum evaporation apparatus of FIG. 6, an aluminum slit was used, and deposition was accomplished at θ2 of 0 degree and at a distance of 60 cm between the support and the slit, while conveying the support to the parallel direction to the support. The stimulable phosphor layer of 300 μm thickness, comprised of columnar crystals of θ1=0 degree and crystal diameter of 3 μm was obtained, which was observed with an electron microscope.

When evaporation was accomplished, the foregoing support was provided in the vacuum evaporation apparatus, and then, raw material of phosphor, as an evaporation source (CsBr:Eu), which was previously molded in a press was provided in a water-cooled crucible.

Thus, the deposition apparatus was evacuated to a vacuum degree of 6.55×10⁻⁴ Pa, and then deposition was started with maintaining a support temperature (called also a substrate temperature) at about 300° C. Deposition was finished when the thickness of the stimulable phosphate layer reached to 300 μm.

The support having formed the stimulable phosphor layer thereon was immediately transferred to a working chamber (water partial pressure of 2.66×10³ Pa), a glass spacer of 600 μm thick and 5 mm width was placed on the support to provide an air layer of 300 μm thick around the stimulable phosphor layer, and then an adhesion process was performed using an epoxy type adhesive (produced by Three Bond Co., Ltd.), in which a notched part was not provided.

Further, radiation image conversion panel sample 1 quickly sealing the glass used as a protective layer prepared separately in the following manner was superposed thereto and sealed, with an epoxy type adhesive to prepare radiation image conversion panel sample 1.

The protective layer made of glass was prepared in the following manner. The following pigment dispersion coating solution was directly applied on the surface of the non-colored transparent glass (550 μm thick, refractive index of 1.52, transmittance of 98% on the stimulated luminescence) using a bar coater with adjusting thickness to obtain transmittance of 85%, and dried.

Pigment Dispersion Coating Solution

| | | |
|---|---|---|
| Copper phthalocyanine | 1.0 | g |
| Polyvinyl butyral | 1,000 | g |
| Methyl Ethyl Ketone | 10,000 | g |

The coating solution was prepared to disperse above materials for 6 hours using a sand mill (DYNO-MILL KD-60, manufactured by Willey A. Backofen AG.).

Subsequently, the support having formed the foregoing stimulable phosphor layer thereon was transferred to a working chamber (water partial pressure of 4.00×10³ Pa), a glass spacer of 600 μm thick and 5 mm width was placed on the support to provide an air layer of 300 μm thick around the stimulable phosphor layer, and then an adhesion process was performed using an epoxy type adhesive (produced by Three Bond Co., Ltd.), in which a notched part was not provided.

The thus obtained support having formed the spacer around the stimulable phosphor layer was dried under reduced pressure (degree of vacuum of 1.33 Pa) at 80° C. for 2 hr. and picked out to other working chamber (water partial pressure of 2.66×10³ Pa). After providing the above mentioned glass protective layer on the spacer, the contacting portion of the spacer and the protective layer was allowed to adhere with an epoxy type adhesive to seal the stimulable phosphor layer to prepare radiation image conversion panel sample 2.

Radiation image conversion panel sample 3 was prepared in the same manner as the preparation of radiation image conversion panel sample 2, except that the support having formed the stimulable phosphor layer thereon was transferred to a working chamber (water partial pressure of 4.00×10³ Pa), the spacer was adhered to the support, and then the support was dried under reduced pressure having degree of vacuum of 1.33×10³ Pa at 80° C. for 2 hr. and picked out to a working chamber having a water partial pressure of 1.33×10³ Pa, and after providing the protective glass thereon, the adhesion process was performed similarly

Radiation image conversion panel sample 4 was prepared in the same manner as the preparation of radiation image conversion panel sample 2, except that after similarly drying under reduced pressure, the support was picked out to a working chamber having a water partial pressure of 0.66×10³ Pa, and the sealing process was performed similarly after providing the protective glass thereon.

Radiation image conversion panel sample 5 (comparative sample) was prepared in the same manner as the preparation of radiation image conversion panel sample 2 except that after sealing of the spacer and 2 hr., followed by drying under reduced pressure at 80° C. (vacuum degree of 1.33 Pa), the support was picked out to a working chamber of absolute humidity of 6.55×10³ Pa, and the sealing process was performed similarly after providing the protective glass thereon.

The sample in which the protective glass was sealed to provide an open area in a notched part was prepared in the same manner as the preparation of radiation image conversion panel sample 2, except that after the stimulable phosphor layer was formed on the support, the spacer having a notched part such as notched part 6 (d=10 mm) shown in FIG. 1(b) was used as the spacer to be sealed to foregoing support. An open area ratio of the notched part in the spacer is 0.0018%.

And then, the sample which was tentatively sealed using the spacer having the notched part was dried under reduced pressure (vacuum degree of 1.33 Pa) at 80° C. for 2 hr. in a vacuum dryer. Then, radiation image conversion panel sample 6 (comparative sample) was prepared by sealing similarly with a adhesive agent after above sample was picked out to a working chamber having a water partial pressure of 2.66×10³ Pa.

The sample was dried under reduced pressure (vacuum degree of 1.33 Pa) at 80° C. for 2 hr. with evacuating from the notched part (the open area) using a pressure reducing pump. And then, radiation image conversion panel sample 7 (comparative sample) was prepared by sealing similarly with a adhesive agent to provide the protective glass thereon after above sample was picked out to a working chamber having a water partial pressure of 1.33×10³ Pa.

Radiation image conversion panel samples 1 through 7 prepared like this were evaluated with respect to sensitivity as in the following.

Evaluation of Radiation Image Conversion Panel

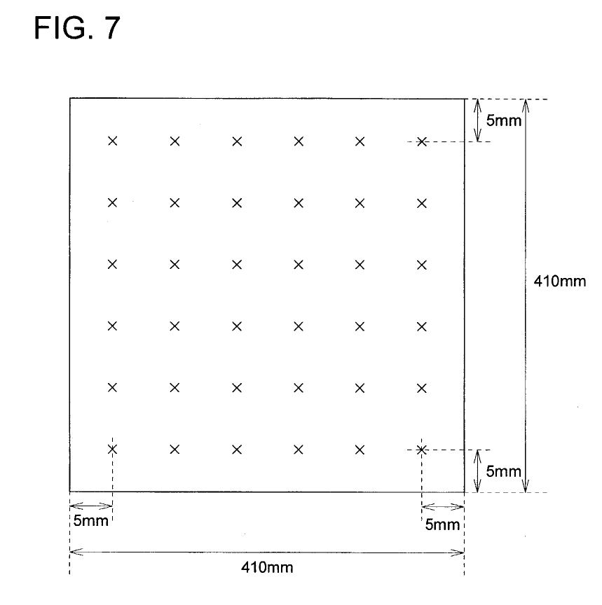

After each of the panels were exposed to X-ray of 10 mR at 80 kVp (at a distance to the subject: 1.5 m) and irradiated with semiconductor laser light (680 nm, a power of 40 nW on the panel), luminance of the panel to X-ray was determined from obtained intensity of signal was defined as sensitivity. Luminance of the panel was the average of the measure values of 360 points at regular intervals from the center to the fringe portion of the radiation image conversion panel as shown in FIG. 7. The diameter of laser beam was 100 μmφ. Sensitivity of each panel was determined by a relative value, based on that of radiation image conversion panel 1 being 100.

TABLE 1

| Radiation Image | Relative | Sealing | |
|---|---|---|---|
| Conversion Panel | Sensitivity | Method | Remarks |
| 1 | 100 | — | Inv. |
| 2 | 103 | — | Inv. |
| 3 | 110 | — | Inv. |
| 4 | 114 | — | Inv. |
| 5 | 85 | — | Comp. |
| 6 | 90 | With a | Comp. |
| | | Notched part | |
| 7 | 94 | Without a | Comp. |
| | | Notched part | |

Inv.; Inventive, Comp.; Comparative

As can be seen from Table 1, it was proved that radiation image conversion panel samples of the present invention exhibited high sensitivity as compared to comparative samples.

[Effect of the Invention]

According to the present invention, there were provided a method of preparing a radiation image conversion panel exhibiting superior production stability and higher sensitivity.

What is claimed is:

1. A preparing method of a radiation image conversion panel comprising:
forming a stimulable phosphor layer on a support while the stimulable phosphor layer being unformed on a peripheral portion around the stimulable phosphor layer on the support; and
sealing the stimulable phosphor layer by superimposing a protective layer on the support formed thereon the stimulable phosphor layer while providing an adhesive agent on the peripheral portion,
wherein the sealing step is conducted under a condition controlling humidity so that a moisture content of the stimulable phosphor layer is lower than the moisture content maintaining equilibrium with an atmosphere having a water partial pressure of 2.66×10³ Pa.

2. A preparing method of a radiation image conversion panel comprising:
forming a stimulable phosphor layer on a support while the stimulable phosphor layer being unformed on a peripheral portion around the stimulable phosphor layer on the support;
fixing a spacer on the peripheral portion by utilizing an adhesive agent so as to surround the stimulable phosphor layer; and
sealing the stimulable phosphor layer by superimposing a protective layer on the spacer while providing an adhesive agent on the spacer,
wherein the sealing step is conducted under a condition controlling humidity so that a moisture content of the stimulable phosphor layer is lower than the moisture content maintaining equilibrium with an atmosphere having a water partial pressure of 2.66×10³ Pa.

3. A preparing method of a radiation image conversion panel comprising:
forming a stimulable phosphor layer on a support while the stimulable phosphor layer being unformed on a peripheral portion around the stimulable phosphor layer on the support;
fixing a protective layer on the support by providing an adhesive agent while a part of the peripheral portion being kept un-adhered so that an open area ratio of a space including the stimulable phosphor layer is not less than 10%; and
sealing the stimulable phosphor layer with the protective layer and the support by providing an adhesive agent to the un-adhered part of the peripheral portion,
wherein the sealing step is conducted under a condition controlling humidity so that a moisture content of the stimulable phosphor layer is lower than the moisture content maintaining equilibrium with an atmosphere having a water partial pressure of 2.66×10³ Pa.

4. A preparing method of a radiation image conversion panel comprising:
forming a stimulable phosphor layer on a support while the stimulable phosphor layer being unformed on a peripheral portion around the stimulable phosphor layer on the support;
fixing a spacer on the peripheral portion and fixing a protective layer on the spacer with utilizing an adhesive agent, the spacer having a notched part so that an open area ratio of a space including the stimulable phosphor layer is not less than 10%; and
sealing the stimulable phosphor layer by closing the notched part of the spacer,
wherein the sealing step is conducted under a condition controlling humidity so that a moisture content of the stimulable phosphor layer is lower than the moisture content maintaining equilibrium with an atmosphere having a water partial pressure of 2.66×10³ Pa.

5. The preparing method of claim 1, wherein the sealing step is conducted under a condition controlling humidity so that a moisture content of the stimulable phosphor layer is lower than the moisture content maintaining equilibrium with an atmosphere having a water partial pressure of 1.33×10³ Pa.

6. The preparing method of claim 2, wherein the sealing step is conducted under a condition controlling humidity so that a moisture content of the stimulable phosphor layer is lower than the moisture content maintaining equilibrium with an atmosphere having a water partial pressure of 1.33×10³ Pa.

7. The preparing method of claim 5, wherein the sealing step is conducted under a condition controlling humidity so that a moisture content of the stimulable phosphor layer is lower than the moisture content maintaining equilibrium with an atmosphere having a water partial pressure of 0.66×10³ Pa.

8. The preparing method of claim 6, wherein the sealing step is conducted under a condition controlling humidity so that a moisture content of the stimulable phosphor layer is lower than the moisture content maintaining equilibrium with an atmosphere having a water partial pressure of 1.33×10³ Pa.

9. The preparing method of claim 1, wherein the stimulable phosphor layer contains stimulable phosphor represented by following Formula (1), and the stimulable phosphor layer is formed to be a thickness of not less than 50 μm by a vapor growth method,
M¹X.aM²X′₂.bM³X″₃:cA Formula (1)
wherein M¹ represents an alkali metal selected from the group consisting of Li, Na, K, Rb and Cs; M² represents a divalent metal selected from the group consisting of Be, Mg, Ca, Sr, Ba, Zn, Cd, Cu and Ni; M³ represents a trivalent metal selected from the group consisting of Sc, Y, La, Ce, Pr, Nd, Pm, Sm, Eu, Gd, Tb, Dy, Ho, Er, Tm, Yb, Lu, Al, Ga and In; X, X′ and X″ each represent a halogen selected from the group consisting of F, Cl, Br and I; A represents a metal selected from the group consisting of Eu, Tb, In, Ga, Cs, Ce, Tm, Dy, Pr, Ho, Nd, Yb, Er, Gd, Lu, Sm, Y, Tl, Na, Ag, Cu and Mg; and a, b and c each represent 0≦a<0.5, 0≦b<0.5, 0<c≦0.2.

10. The preparing method of claim 9, wherein in Formula (1), M¹ represents an alkali metal selected from the group consisting of K, Rb and Cs.

11. The preparing method of claim 9, wherein in Formula (1), X represents a halogen atom selected from Br and I.

12. The preparing method of claim 9, wherein in Formula (1), M² represents a divalent metal selected from the group consisting of Be, Mg, Ca, Sr and Ba.

13. The preparing method of claim 9, wherein in Formula (1), M³ represents a trivalent metal selected from the group consisting of Y, Ce, Sm, Eu, Al, La, Gd, Lu, Ga and In.

14. The preparing method of claim 9, wherein in Formula (1), b represents 0≦b≦0.01.

15. The preparing method of claim 9, wherein in Formula (1), A represents a metal selected from the group consisting of Eu, Cs, Sm, Tl and Na.

16. The preparing method of claim 2, wherein the stimulable phosphor layer contains stimulable phosphor represented by following Formula (1), and the stimulable phosphor layer is formed to be a thickness of not less than 50 μm by a vapor growth method,
M¹X.aM²X′₂.bM³X″₃:cA Formula (1)
wherein M¹ represents an alkali metal selected from the group consisting of Li, Na, K, Rb and Cs; M² represents a divalent metal selected from the group consisting of Be, Mg, Ca, Sr, Ba, Zn, Cd, Cu and Ni; M³ represents a trivalent metal selected from the group consisting of Sc, Y, La, Ce, Pr, Nd, Pm, Sm, Eu, Gd, Tb, Dy, Ho, Er, Tm, Yb, Lu, Al, Ga and In; X, X′ and X″ each represent a halogen selected from the group consisting of F, Cl, Br and I; A represents a metal selected from the group consisting of Eu, Tb, In, Ga, Cs, Ce, Tm, Dy, Pr, Ho, Nd, Yb, Er, Gd, Lu, Sm, Y, Tl, Na, Ag, Cu and Mg; and a, b and c each represent 0≦a<0.5, 0≦b<0.5, 0<c≦0.2.

17. The preparing method of claim 16, wherein in Formula (1), M¹ represents an alkali metal selected from the group consisting of K, Rb and Cs.

18. The preparing method of claim 16, wherein in Formula (1), X represents a halogen atom selected from Br and I.

19. The preparing method of claim 16, wherein in Formula (1), M² represents a divalent metal selected from the group consisting of Be, Mg, Ca, Sr and Ba.

20. The preparing method of claim 16, wherein in Formula (1), M³ represents a trivalent metal selected from the group consisting of Y, Ce, Sm, Eu, Al, La, Gd, Lu, Ga and In.

21. The preparing method of claim 16, wherein in Formula (1), b represents 0≦b≦0.01.

22. The preparing method of claim 16, wherein in Formula (1), A represents a metal selected from the group consisting of Eu, Cs, Sm, Tl and Na.

23. The preparing method of claim 1, wherein the stimulable phosphor layer comprises stimulable phosphor having columnar crystals.

24. The preparing method of claim 23, wherein the columnar crystals contain stimulable phosphor represented by following Formula (2) as a primary component,
CsX:A Formula (2)
wherein in Formula (2), X represents Br or I, A represents Eu, In, Ga or Ce.

25. The preparing method of claim 1, wherein the stimulable phosphor layer is formed on the support by a vapor growth method.

26. The preparing method of claim 2, wherein the stimulable phosphor layer is formed on the support by a vapor growth method.
